(19) United States
(12) Patent Application Publication
(10) Pub. No.: US 2008/0219251 A1
(43) Pub. Date: Sep. 11, 2008

(54) Combining packets in physical layer for two-way relaying

(76) Inventors: Feng Xue, Santa Clara, CA (US); Sumeet Sandhu, Santa Clara, CA (US)

Correspondence Address: INTEL CORPORATION;c/o INTELLEVATE, LLC, P.O. BOX 52050, MINNEAPOLIS, MN, 55402, US

(21) Appl. No.: 11/715,547

(22) Filed: Mar. 8, 2007

(51) Int. Cl. H04L 12/56

(52) U.S. Cl. 370/389

(57) ABSTRACT

A method of transmitting two packets to two different nodes may include encoding a first packet according to a first channel to obtain an encoded first packet and encoding a second packet according to a second channel different than the first channel to obtain an encoded second packet. The encoded first packet and the encoded second packet may be combined to obtain a combined encoded packet. The method may include mapping the combined encoded packet to symbols for transmission. The symbols may be transmitted to the two different nodes over the first channel and the second channel.

### BACKGROUND

Implementations of the claimed invention generally may relate to wireless communication, and in particular to two-way relaying of packets between wireless nodes.

Wireless relay stations have been proposed to extend the coverage of traditional base stations in wireless communication networks. The basic function of such relays may be to relay packets from the base stations to end subscriber stations and vice versa. This bi-directional function may be referred to in shorthand as “two-way relaying.” Also, in wireless mesh networks, wireless access points may function as relays, for example between a wire-line network and end users. Utilization of relays to increase spectrum efficiency is a significant concern of system designers.

Recently a scheme has been proposed to increase throughput in wireless networks by combining packets by a relay station that were sent by two nodes to each other. The combined packet is transmitted by the relay station to both nodes, which decode it appropriately to recover “their” packet. This scheme typically occurs at the Media Access Controller (MAC) layer or a higher layer in the ISO seven layer open system interconnect (OSI) network model, and is thus referred to as “network coding.”

Such network coding as conventionally implemented, however, may be less than optimal for various reasons.

### BRIEF DESCRIPTION OF THE DRAWINGS

The accompanying drawings, which are incorporated in and constitute a part of this specification, illustrate one or more implementations consistent with the principles of the invention and, together with the description, explain such implementations. The drawings are not necessarily to scale, the emphasis instead being placed upon illustrating the principles of the invention. In the drawings,

FIG. 1 illustrates an example wireless communication system according to some implementations;

FIG. 2 illustrates an example node in the wireless communication system of FIG. 1;

FIG. 3A illustrates a method of transmitting two packets by a relay node;

FIGS. 3B and 3C conceptually illustrate examples of the method of FIG. 3A;

FIG. 4A illustrates a method of receiving information from a relay node;

FIGS. 4B and 4C conceptually illustrate examples of the method of FIG. 4A; and

FIG. 5 conceptually illustrates a performance advantage of the scheme outlined in FIGS. 3 and 4.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of the claimed invention. However, it will be apparent to those skilled in the art having the benefit of the present disclosure that the various aspects of the invention claimed may be practiced in other examples that depart from these specific details. In certain instances, descriptions of well known devices, circuits, and methods are omitted so as not to obscure the description of the present invention with unnecessary detail.

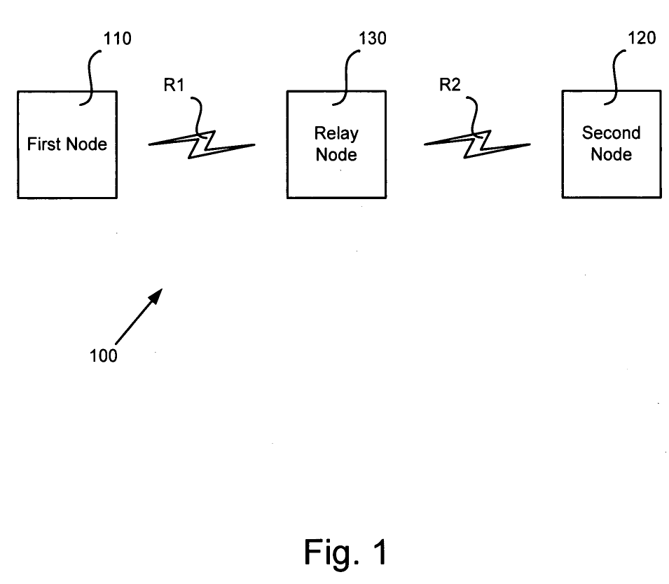

FIG. 1 is a diagram illustrating an example of a wireless system 100 in accordance with one implementation consistent with the principles of the invention. System 100 may include first node 110, second node 120, and relay node 130. System 100, which may be an ad hoc network, may also include other nodes, wireless and/or wired, that are not shown. In some implementations, first node 110 may include a base station, and/or second node 120 may include a subscriber or mobile station. It should be noted, however, that first and second nodes 110/120 may be any combination or type of nodes typically found in a wireless system 100.

Relay node 130 may be located between first node 110 and second node 120, although relay node 130 need not be located along a shortest-distance line between first node 110 and second node 120. In general, relay node 130 may be closer to, for example, first node 110 than second node 120 is.

Relay node 130 may communicate with first node 110 via communication channel RI, which may have an associated capacity or bandwidth. Relay node 130 may communicate with second node 120 via communication channel R2, which may have a different associated capacity or bandwidth than channel R1, although it may in some instances be similar to that of channel R1.

Channels R1 and R1 may be wireless, optical, wireline, and/or other formats that are suitable for communication between nodes (or any combination thereof). Within these parameters, the transmission at the relay node 130 generally may be broadcast in nature, in that both receivers (e.g., nodes 110/120) can hear it at roughly the same time. The point-to-point communication between nodes may proceed with encoding the information bits according to the channel conditions and then mapping from bits to modulation points. In wireless communications, modulation may include 8 QAM, 16 QAM, etc. In wireline (or other non-wireless) communications, modulation may include on-off keying (‘0’ maps to ‘off’ and ‘1’ maps to ‘on’), pulse position modulation, pulse-amplitude modulation (PAM), etc. PAM is typically used in Ethernet networks. If the two channels R1 and R2 have different link qualities, then the scheme described herein may achieve better performance than other approaches, whether channels R1 and R2 are wireless or not.

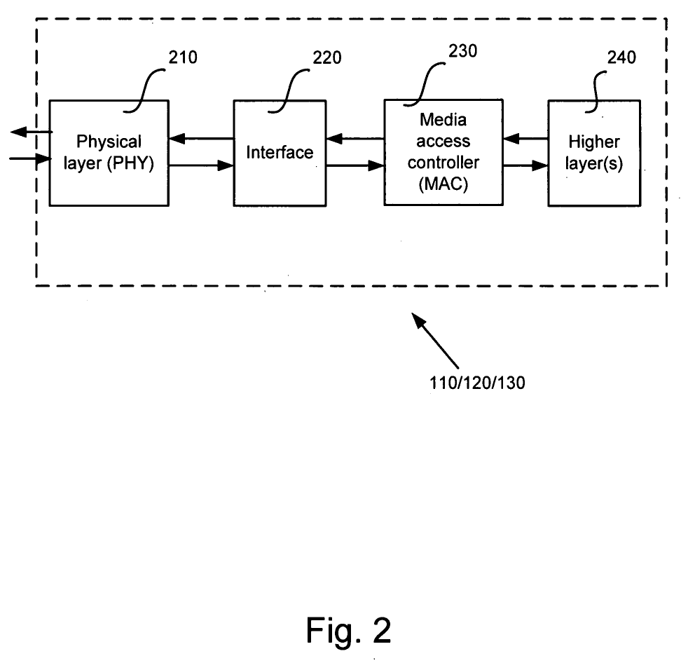

FIG. 2 illustrates an example node 110/120/130 in the wireless communication system 100. Node 110/120/130 may include a physical layer (PHY) 210, an interface 220, a media access controller (MAC) 230, and one or more higher layers 240. In some implementations, one or more of elements 210-240 may not be present in a node. In some implementations, one or more of elements 210-240 may be functional components of a single device, and their separate illustration in FIG. 2 does not necessarily indicate that elements 210-240 are physically separate components, although they may be.

PHY 210 may define the electrical, mechanical, procedural, and functional specifications for activating, maintaining, and deactivating the physical link(s) (e.g., R1 and/or R2) between nodes. PHY 210 may define characteristics such as voltage levels, timing of voltage changes, physical data rates, maximum transmission distances, and/or physical connectors. In some implementations, PHY 210 may include circuitry necessary to physically communicate with other nodes, including for example one or more antennas (e.g., a directional antenna and/or an omni-directional antenna), a power amplifier, a demodulator, a decoder, etc. In addition, PHY 210 also may include circuitry or logic to perform the combining (and/or decombining) of packets or chunks of information as described in further detail below.

PHY 210 may include, in some implementations, a wireless area network (WAN) transceiver, such as one that supports an Institute of Electrical and Electronics Engineers (IEEE) wireless communication standard like IEEE 802.11a/b/g or IEEE 802.16 or another similarly-used radio frequency (RF) protocol. PHY 210 may include, in some implementations, a cellular transceiver, such as one that supports a so-called 3G or 4G cellular communication protocol such as Global System for Mobile Communications (GSM), General Packet Radio Service (GPRS), Enhanced Data GSM Environment (EDGE), European Telecommunications Standards Institute (ETSI), Wideband CDMA (WCDMA), Long Term Evolution (LTE) (e.g., Super 3G), or High-Speed Downlink Packet Access (HSDPA), although cellular transceivers that support other RF protocols than these are both possible and contemplated. For non-wireless communications, however, PHY 210 may include suitable electrical and/or optical transceivers.

As is typical in an OSI system, PHY 210 may be coupled to MAC 230 via an interface 220. Interface 220 may include, in some implementations, a media independent interface (MII) or an attachment unit interface (AUI), or any variant thereon typically found between a physical layer and a media controller layer in wireless (or wired) communication systems.

MAC 230 may include circuitry or software functionality to define how the physical channel (e.g., R1 and/or R2) may be accessed. MAC 230 may provide, for example, a limited form of error control, especially for any header information which defines the media access control-level destination and higher-layer access mechanism. MAC 230 may also perform other functions typically performed by the media access control portion of a data layer in an OSI system.

Higher layer(s) 240 may include any or all of a network layer, a transport layer, a session layer, a presentation layer, or an application layer. These layers may perform the functions generally associated with them in a typical OSI system, and in particular a wireless communication system.

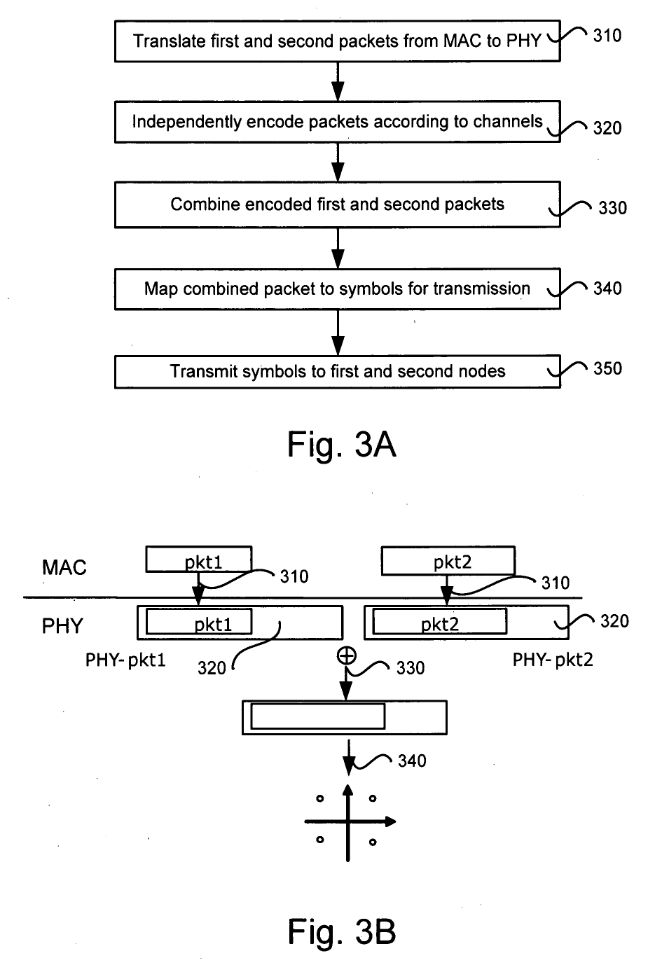

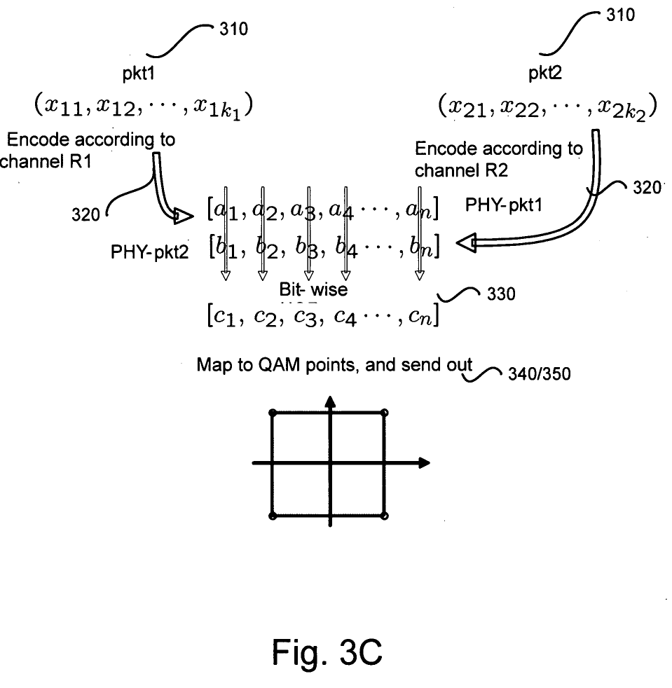

FIG. 3A illustrates a method of transmitting two packets from first and second nodes 110/120 by relay node 130. Although described with respect to FIGS. 1 and/or 2 for ease of explanation, the scheme described in FIG. 3A should not be construed as limited to the particulars of these other figures.

As a precursor, relay node 130 has received two packets from first node 110 and second node 120 that are destined for second node 120 and first node 110, respectively. The method may begin with relay node 130 translating the two packets from MAC layer 230 to PHY layer 210 [act 310]. Such packet translation may occur, for example, via interface 220. After the translation in act 310, subsequent processing by relay node 130 may occur in PHY layer 210.

Processing may continue with relay node 130 independently encoding the two packets according to the channels (e.g., R1 and R2) between relay node 130 and the packets' respective destination nodes [act 320]. For example, if the first packet is destined for the first node 110, it may be encoded in PHY 210 according to channel R1 between relay node 130 and first node 110. Similarly, if the second packet is destined for the second node 120, it may be encoded in PHY 210 according to channel R2 between relay node 130 and second node 120. In this manner, the PHY-layer packets may be independently encoded in act 320 according to the particulars of the communication channels or paths to their respective destination nodes 110/120. Although the first and second packets may be encoded at roughly the same time, relay node 130 may encode them as available, for example, from a queue of packets from nodes 110/120.

Example schemes for encoding the first and second packets in act 320 include linear block codes, convolutional codes, Low Density Parity Check (LDPC) codes, although the claimed invention is not limited in this regard.

PHY 210 of relay node 130 may combine the encoded first and second packets to produce a combined encoded packet [act 330]. Such combination may include a logical combination, such as a bitwise exclusive OR (XOR), but is not limited thereto. The combination in act 330 may include any logical, arithmetic, or any other combinatory scheme or mapping of two encoded packets from which one packet may be recovered (e.g., by the destination node 110/120) given knowledge of the other packet (e.g., the one sent by the destination node). Although such combinations in act 330 may include logical bitwise operations, such as a bitwise XOR, they are not limited to either bitwise combinations or logical combinations.

The combined encoded packet may be mapped via PHY 210 to one or more constellation symbols in preparation for transmission [act 340]. Such a mapping may include, for example, Quadrature Amplitude Modulation (QAM), for example within a frequency division multiplexing (FDM) scheme. For example, an orthogonal FDM modulation (OFDM) may use QAM on each subcarrier, although the claimed invention is not limited in this regard.

The method may continue with relay node 130 transmitting the symbols to the first node 110 and the second node 120 [act 350]. In one implementation, relay node 130 may broadcast the symbols representing the combined encoded packet on both communication channels (e.g., R1 and R2) between it and first and second nodes 110/120. In one implementation, relay node 130 may generally broadcast (e.g., omni-directionally) the symbols representing the combined encoded packet without regard to any particular destination. In any event, a common set of symbols is transmitted to both nodes 110 and 120 in act 350, to be decoded as appropriate by the receiving node(s).

FIG. 3B conceptually illustrates one example of the method of FIG. 3A. In FIG. 3B, pkt1 is a packet destined for first node 110, and pkt2 is a packet destined for second node 120. In act 310, pkt1 and pkt2 may be translated from the MAC layer to the PHY layer. In act 320, pkt1 may be encoded according to its transmission channel to form the encoded PHY-pkt1. Also in act 320, pkt2 may be encoded according to its transmission channel to form the encoded PHY-pkt2.

In act 330 in FIG. 3B, PHY-pkt1 and PHY-pkt2 may be combined (e.g., XORed) to form a combined PHY-pkt. This combined PHY-pkt may then be mapped to symbols for transmission in act 340. Although not explicitly shown in FIG. 3B, act 350, transmission of the symbols by relay node 130 may also occur. Also apparent from FIG. 3B is that acts 320-350 occur in the PHY layer, such as PHY layer 210.

FIG. 3C conceptually illustrates another example of the method of FIG. 3A. In FIG. 3C, pkt1 is a packet destined for first node 110, and pkt2 is a packet destined for second node 120. The translation act 310 has already been performed to obtain pkt1 (x₁₁, . . . , x₁ₖ) and pkt2 (x₂₁, . . . , x₂ₖ). In act 320, pkt1 may be encoded according to its transmission channel, R1, to form the encoded PHY-pkt1 (a₁₁, . . . , a₁ₖ). Also in act 320, pkt2 may be encoded according to its transmission channel, R2, to form the encoded PHY-pkt2 (b₁₁, . . . , b₁ₖ).

In act 330 in FIG. 3C, PHY-pkt1 (a₁, . . . , aₙ) and PHY-pkt2 (b₁, . . . , bₙ) may be bitwise combined (e.g., XORed) to form a combined PHY-pkt (c₁, . . . , cₙ). This combined PHY-pkt may then be mapped to QAM points in act 340 and transmitted to first and second nodes 110/120 in act 350.

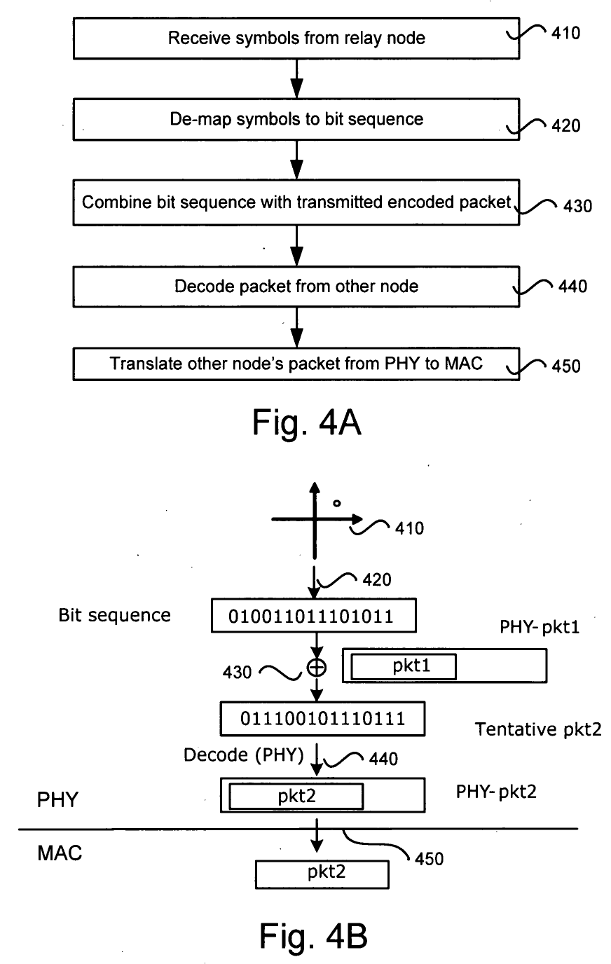

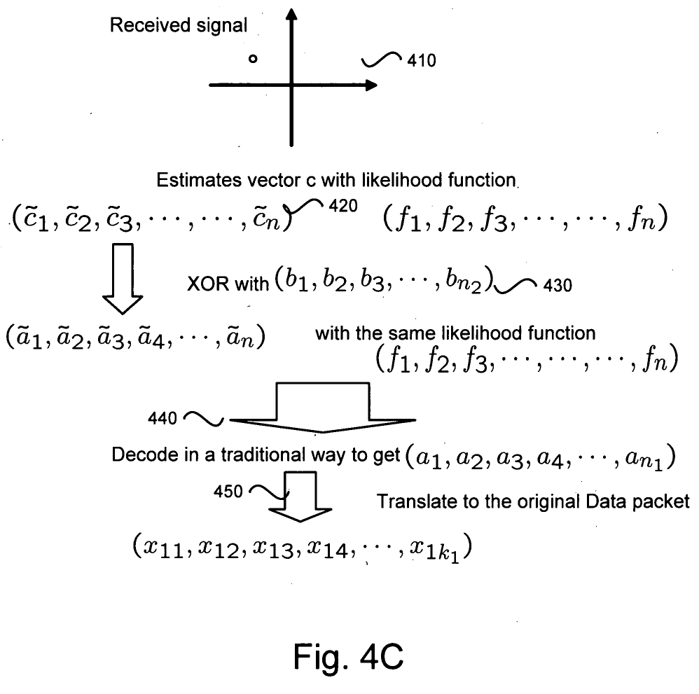

FIG. 4A illustrates a method of receiving a packet from relay node 130 by one of first and second nodes 110/120. Although described with respect to FIGS. 1 and/or 2 for ease of explanation, the scheme described in FIG. 4A should not be construed as limited to the particulars of these other figures. Further, the method presented is largely the same for first and second nodes 110/120, differing in a relatively minor respect with regard to act 430.

The method may begin with one of first node 110 and second node 120 receiving symbols or QAM points from relay node 130 [act 410]. These symbols may be de-mapped to a bit sequence [act 420]. In act 420, a bit sequence may be estimated from the received symbols with an associated probability function.

Next the receiving node may combine the estimated bit sequence with a PHY-packet that it sent to relay node 130 [act 430]. Conceptually, this combination is the opposite or the inverse of the combination that relay node 130 performed in act 330 to generate the combined packet. The aim of act 430 is to extract the packet sent to the receiving node from the received (combined) bit sequence using the packet that it sent (e.g., the packet sent to first node 110 if the receiving node is second node 120, or the packet sent to second node 120 if the receiving node is first node 110).

In some implementations, the combination in act 430 may include a bitwise logical operation similar to that performed in act 330. In some implementations, in act 430 the receiving node may bitwise XOR the received bit sequence with the packet it sent to the other node via receiving node 130. The claimed invention should not be limited in this regard. Any function that will produce the packet destined for the receiving node from 1) the received bit sequence and 2) the PHY-packet that the receiving node sent will suffice in act 430. The combination in act 430, in effect, strips out any influence of the receiving node's sent packet caused by the combination by relay node 130 in act 330, leaving only the packet sent by the other node.

Processing may continue with PHY layer 210 in the receiving node decoding the tentative bit sequence to produce the PHY-packet sent from the other node via relay node 130 [act 440]. Such decoding in the PHY layer 210 of the receiving node (e.g., first node 110 or second node 120) may produce a PHY-layer representation of the packet sent by the other node (e.g., second node 120 or first node 110, respectively). Finally, the receiving node may translate the PHY-packet to a packet in MAC layer 230 [act 450]. Such translation may occur, in some implementations, via interface 220 between PHY 210 and MAC 230. 100401 FIG. 4B conceptually illustrates one example of the method of FIG. 4A. The method shown in FIG. 4B is performed by second node 120, because in keeping with earlier convention, pkt1 is a packet destined for first node 110, and pkt2 is a packet destined for second node 120. In act 410, PHY 210 of second node 120 may receive symbols from relay node 130. In act 420, the received symbols may be de-mapped into an estimated bit sequence. This bit sequence may correspond to the encoded combined PHY packet produced by relay node 130 in act 330, without considering transmission errors or other effects of channel R2.

In act 430 in FIG. 4B, this bit sequence may be combined (e.g., XORed) with PHY-pkt1 (the PHY packet that second node 120 sent to first node 110) to extract a bit sequence that corresponds to a tentative pkt2. Such combination in act 430 may remove any influence of pkt1 from the received (combined) bit sequence sent by relay node 130. This bit sequence that tentatively corresponds to pkt2 may be decoded by PHY 210 in act 440 to produce PHY-pkt2. In act 450, PHY-pkt2 may be translated from the PHY layer to the MAC layer. As may be seen from FIG. 4B, acts 410-440 occur in the PHY layer, such as PHY layer 210 in second node 120.

FIG. 4C conceptually illustrates one example of the method of FIG. 4A. For completeness of explanation, the method shown in FIG. 4C is performed by first node 110. In act 410, PHY 210 of first node 110 may receive symbols from relay node 130. In act 420, the received symbols may be de-mapped into an estimated vector ĉ (ĉ₁, . . . , ĉₙ), which is also a bit sequence. This bit sequence may correspond to the encoded combined PHY packet produced by relay node 130 in act 330, subject to a likelihood function f (f₁, . . . , fₙ).

In act 430 in FIG. 4C, this vector c may be combined (e.g., XORed) with vector b (b₁, . . . , bₙ) (the PHY packet that first node 110 sent to second node 120) to extract a vector ã (ã₁, . . . , ãₙ) that corresponds to a tentative packet from second node 120. Such combination in act 430 may remove any influence of sent vector b from the received (combined) vector c sent by relay node 130. This vector ã may be decoded by PHY 210 of first node 110 in act 440 to produce PHY-vector a (a₁, . . . , aₙ) that was sent from second node 120. In act 450, PHY-vector a (a₁, . . . , aₙ) may be translated from the PHY layer to the MAC layer to obtain the original MAC data packet x (x₁, . . . , xₙ) that was sent from first node 110. 100441 The above-described scheme and/or system may advantageously combines network coding, which is traditionally on the MAC and upper layers, with PHY-layer encoding and processing. The scheme herein may separate the two PHY-layer channels by separately encoding packets before combining them, and thus may achieve each channel's capacity.

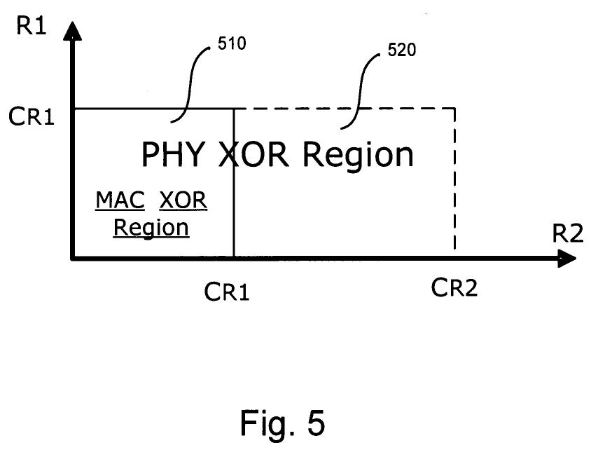

FIG. 5 conceptually illustrates a performance advantage of the scheme outlined in FIGS. 3A-4C relative to a MAC-based scheme. In FIG. 5, the capacity of channel R1 is denoted as C_{R1}, and the capacity of channel R2 is denoted as C_{R2}. For the purposes of exposition, C_{R1} will be lower than C_{R2}, although in some implementations the obverse may be true. Because the method described herein encodes each packet separately in the PHY layer according to its channel (see act 320 and its associated description), it may achieve at or near capacity C_{R1} for transmission to first node 110 along channel R1, and it may achieve at or near capacity C_{R2} for transmission to second node 120 along channel R2. This achievable area is shown as rectangular area 520 in FIG. 5 that is C_{R2} in length and C_{R1} in height.

By way of contrast, a MAC-based network coding scheme may combine packets in the MAC layer, and may encode the combined packet in the PHY layer for both channels. Because the lower capacity channel influences such combined encoding, a MAC-based scheme may only achieve the lower of the two channel capacities, in this case C_{R1}, for both channels R1 and R2. This area of lower MAC-based performance is shown as square area 510 in FIG. 5 that is C_{R1} on a side.

The foregoing description of one or more implementations provides illustration and description, but is not intended to be exhaustive or to limit the scope of the invention to the precise form disclosed. Modifications and variations are possible in light of the above teachings or may be acquired from practice of various implementations of the invention.

For example, although “packets” of data have been referred to, the scheme herein is applicable to chunks of data that are not necessarily packet-based. Also, the scheme herein is also applicable to networks with one or more PHY layers that are not wireless. Other reasonable variations are both possible and contemplated.

No element, act, or instruction used in the description of the present application should be construed as critical or essential to the invention unless explicitly described as such. Also, as used herein, the article “a” is intended to include one or more items. Variations and modifications may be made to the above-described implementation(s) of the claimed invention without departing substantially from the spirit and principles of the invention. All such modifications and variations are intended to be included herein within the scope of this disclosure and protected by the following claims.

What is claimed:

1. A method of transmitting two packets to two different nodes, comprising:
encoding a first packet according to a first channel to obtain an encoded first packet;
encoding a second packet according to a second channel different than the first channel to obtain an encoded second packet;
combining the encoded first packet and the encoded second packet to obtain a combined encoded packet;
mapping the combined encoded packet to symbols for transmission; and
transmitting the symbols to the two different nodes over the first channel and the second channel.

2. The method of claim 1, wherein the encoding the first packet and the encoding the second packet are performed in a physical layer.

3. The method of claim 1, wherein the combining includes:
logically combining the encoded first packet and the encoded second packet to obtain the combined encoded packet.

4. The method of claim 3, wherein the logically combining includes:
exclusive ORing the encoded first packet and the encoded second packet to obtain the combined encoded packet.

5. The method of claim 1, wherein the mapping includes:
transforming the combined encoded packet to one or more quadrature amplitude modulation symbols.

6. The method of claim 1, further comprising:
translating the first packet from a media access control layer before the encoding the first packet; and
translating the second packet from the media access control layer before the encoding the second packet.

7. The method of claim 1, wherein the transmitting includes:
broadcasting the symbols in an omnidirectional manner.

8. A method of receiving a packet from a relay node, comprising:
receiving symbols from the relay node;
generating a first sequence of bits from the received symbols;
combining the first sequence of bits with a physical layer packet that was previously transmitted to the relay node to produce a second sequence of bits; and
decoding the second sequence of bits in a physical layer to produce a received physical layer packet.

9. The method of claim 8, wherein the combining is performed in the physical layer.

10. The method of claim 8, wherein the combining includes:
bitwise combining the first sequence of bits with the physical layer packet that was previously transmitted to obtain the second sequence of bits.

11. The method of claim 10, wherein the bitwise combining includes:
bitwise exclusive ORing the first sequence of bits with the physical layer packet that was previously transmitted to obtain the second sequence of bits.

12. The method of claim 8, further comprising:
translating the received physical layer packet in the physical layer to a received packet in a media.

13. The method of claim 12, wherein the translating is performed via a media independent interface between the physical layer and the media access control layer.

14. A relay node in a wireless system, comprising:
a media access controller to provide a first packet from a first node and a second packet from a second node;
an interface to translate the first packet to a first physical layer packet and to translate the second packet to a second physical layer packet; and
a physical layer to independently encode the first physical layer packet into a first encoded packet and the second physical layer packet into a second encoded packet and to combine the first encoded packet and the second encoded packet into a combined encoded packet.

15. The relay node of claim 14, wherein the physical layer is arranged to map the combined encoded packet into symbols for transmission.

16. The relay node of claim 15, wherein the physical layer is further arranged to transmit the symbols to the first node and the second node.

17. The relay node of claim 14, wherein the physical layer is further arranged to combine the first encoded packet and the second encoded packet into a combined encoded packet by logically combining the first encoded packet and the second encoded packet.

18. The relay node of claim 14, further comprising:
one or more higher layers connected to the media access controller.

19. The relay node of claim 14, wherein the interface includes a media independent interface or an attachment unit interface.

20. A node in a wireless system, comprising:
a physical layer to combine a received bit sequence and a previously transmitted physical layer packet into a combined bit sequence and to decode the combined bit sequence to generate a received physical layer chunk of data; and
an interface connected to the physical layer to translate received physical layer chunk of data into a second chunk of data formatted for a media access control layer.

21. The node of claim 20, further comprising:
a media access controller to receive the second chunk of data from the interface.

22. The node of claim 20, wherein the physical layer is arranged to wirelessly receive symbols from a communication channel and to estimate the received bit sequence from the symbols.

23. The node of claim 20, wherein the physical layer is further arranged to logically combine the received bit sequence and the previously transmitted physical layer packet.
